(19) United States
(12) Patent Application Publication
(10) Pub. No.: US 2017/0205540 A1
(43) Pub. Date: Jul. 20, 2017

(54) UNDERWATER VIEWING DEVICE WITH HANDHELD FACETED VACUUM LENS

(71) Applicant: Danny Austin Doten, Kaplan, LA (US)

(72) Inventor: Danny Austin Doten, Kaplan, LA (US)

(21) Appl. No.: 15/000,085

(22) Filed: Jan. 19, 2016

(51) Int. Cl. G02B 3/12; B63B 19/02; B63B 35/79; G02B 27/02

(52) U.S. Cl. CPC G02B 3/12; G02B 27/027; B63B 19/02; B63B 35/7906

(57) ABSTRACT

The system of the preferred embodiments is an underwater viewer including: A transparent lens, where the transparent lens has at least two flat facets, where the at least two flat facets are arranged to provide an interior cavity having a void adapted to hold fluid; a frame, where the frame is attached around the circumference of the lens, where the joint between the lens and the frame is sealed to prevent fluid flow; where a user can look through the flat facets of the lens into a body of water. The underwater viewer of the preferred embodiments is preferably designed to be at least one of held by a user, floated in a body of water, and incorporated into at least one of a water going board and a water going craft, and it is designed to hold water above the surface of the body of water by way of a vacuum so that a user can look through the lens into the body of water; the flat faceted lens allows viewing into the body of water without distortion, unlike prior art devices, and the fact that the device is preferably used with the convex side of the lens facing upward allows water from waves or other disturbances to run off of the lens due to gravity and not interfere with the user's view into the water. The underwater viewer may, however, be used for any suitable purpose.

### BRIEF DESCRIPTION OF THE FIGURES

FIG. 1 is a schematic representation of a variation of the system of the first preferred embodiments, shown from a top view.

FIG. 2 is a schematic representation of a variation of the system of the first preferred embodiments, shown from a side view and including at least one of foam and an inflatable floatation bladder.

FIG. 3 is a schematic representation of a variation of the system of the first preferred embodiments, shown from a side view in a body of water with a user viewing through the lens into the body of water.

FIG. 4 is a schematic representation of a variation of the system of the first preferred embodiments, shown from the top mounted to at least one of a surf board and a body board.

FIG. 5 is a schematic representation of a variation of the system of the first preferred embodiments, shown from the side mounted to the hull of a water craft.

FIG. 6 is a schematic representation of a variation of the system of the first preferred embodiments, shown from the side with a one-way valve in the apex of the lens allowing fluid to flow out of the interior cavity of the lens, providing a means to draw water into the interior cavity of the lens and support it above the level of the surface of the body of water.

FIG. 7 is a schematic representation of a variation of the system of the first preferred embodiments, wherein at least one of a concave section and a convex section is included in at least one facet of the lens.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

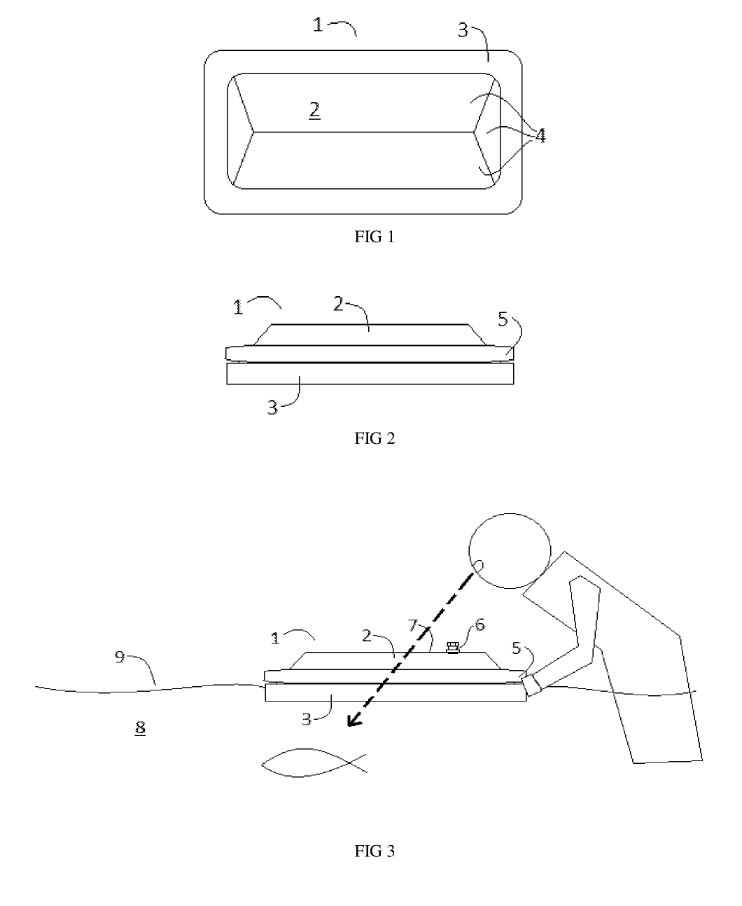

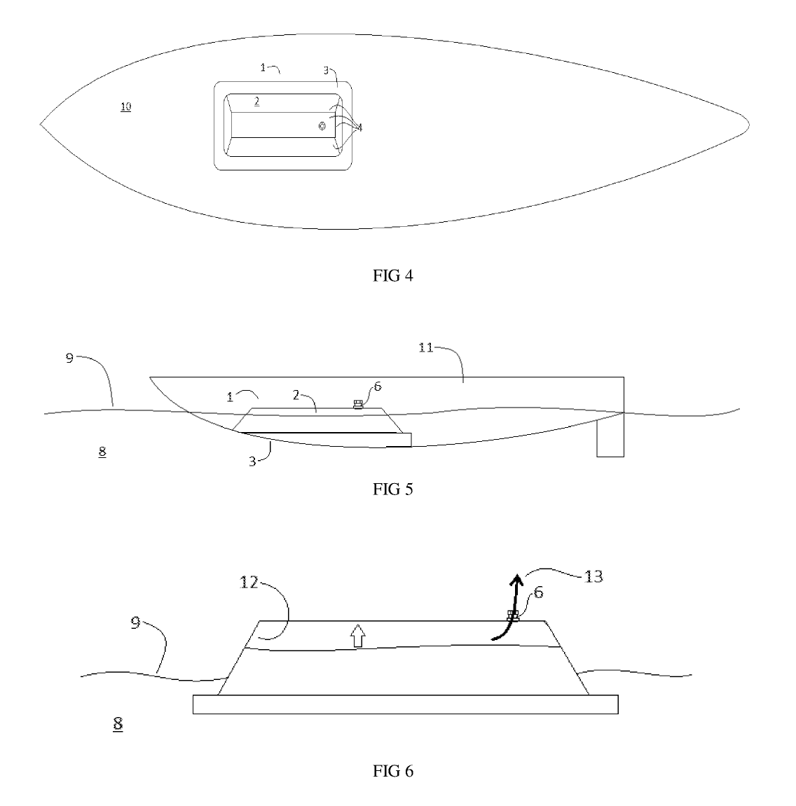

As shown in FIG. 1, the system of the preferred embodiments is an underwater viewer 1 including: A transparent lens 2, where the transparent lens 2 has at least two flat facets 4, where the at least two flat facets 4 are arranged to provide an interior cavity 12 having a void adapted to hold fluid; a frame 3, where the frame 3 is attached around the circumference of the lens 2, where the joint between the lens 2 and the frame 3 is sealed to prevent fluid flow 13; where a user can look through the flat facets 4 of the lens 2 into a body of water 8. The underwater viewer 1 of the preferred embodiments is preferably designed to be at least one of held by a user, floated in a body of water 8, and incorporated into at least one of a water going board and a water going craft, and it is designed to hold water above the surface 9 of the body of water 8 by way of a vacuum so that a user can look through the lens 2 into the body of water 8; the flat faceted lens 2 allows viewing into the body of water 8 without distortion, unlike prior art devices, and the fact that the device is preferably used with the convex side of the lens 2 facing upward allows water from waves or other disturbances to run off of the lens 2 due to gravity and not interfere with the user's view into the water. The underwater viewer 1 may, however, be used for any suitable purpose.

As shown in FIG. 3, in one preferred variation the underwater viewer 1 is held by a user in a body of water 8 with the convex side of the faceted lens 2 facing upward. The user preferably manipulates the underwater viewer 1 such that the interior cavity 12 of the lens 2 is filled with water and the water is held in the cavity 12 above the level of the surface 9 of the body of water 8 by vacuum. The interface between the lens 2 and the water, with the water in the lens 2 cavity 12 being in continuous communication with the body of water 8 allows the user to easily see through the lens 2 and into the body of water 8 with an uninterrupted and clear view. The flat facets 4 of the lens 2 preferably prevent the user's view from being distorted, unlike what would occur if the lens 2 had a curved surface. This is one major problem with prior art devices where magnification and distortion of light due to curved lens 2 surfaces leads to distortion of the user's view. In one preferred variation, the lens is made of polycarbonate formed using heat from polycarbonate sheet. In one preferred variation, the frame is at constructed of at least one of polymer and wood and is attached to the lens using at least one of adhesive, molded mechanical interfaces, machined mechanical interfaces, and threaded fasteners. The lens may, however, be formed of any suitable material using any suitable methods. The frame may, however, be constructed of any suitable materials and attached to the lens in any suitable manner. In a preferred variation, the user may flip the lens 2 over underwater, allow the interior lens cavity 12 to fill with water, then flip the lens 2 back over so that the convex side of the lens 2 faces upwards, then pull the lens 2 to the surface such that the exterior of the lens 2 is above the surface 9 of the body of water 8 and the water is held in the lens 2 cavity 12 above the surface 9 of the body of water 8. Preferably having the convex exterior of the lens 2 facing upward and above the surface 9 of the body of water 8 allows any water that is splashed onto the lens 2 or that gets onto the lens 2 from waves to drain off of the exterior of the lens 2 by way of gravity and prevent the view through the lens 2 from being obscured. In prior art devices where a lens 2 with an air filled cavity 12 is pushed below the surface 9 of the body of water 8, any splashed water or water from waves will sit in the cavity 12 on the lens 2 and obscure the user's view into the body of water 8. In a preferred variation, as shown in FIG. 2, at least one of the lens 2 and the frame 3 has at least one of foam 5 and an inflatable floatation bladder 5 attached to it, preferably allowing the underwater viewer 1 to float. The underwater viewer 1 may, however, have any suitable form of floatation. The underwater viewer 1 may, however, have no floatation whatsoever attached to it. The underwater viewer 1 can be used in one preferred variation to comfortably view things including fish, reefs, underwater wildlife, rocks, sunken objects, and any other suitable underwater items, without the user having to keep their head in the body of the water. In another variation, the underwater viewer 1 may be used in an inverted position from what is described above. The underwater viewer 1 may, however, be used in any suitable way, in any suitable orientation, and for any suitable purpose.

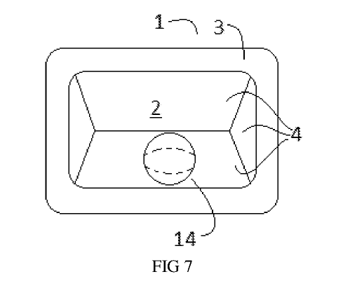

As shown in FIGS. 3 and 6, in a preferred variation a one way valve may be attached to the lens 2 in a manner that allows it to be in fluid communication with the interior lens cavity 12. The one way valve is preferably designed to allow fluid to flow out of the interior lens cavity 12, but not into the interior lens cavity 12. In one preferred variation, this allows a user to hold the underwater viewer 1 with the convex exterior of the lens 2 facing upward and push it down into the water, such that the interior lens cavity 12 fills with water as air in the interior lens cavity 12 escapes through the one-way valve 6. The user can then pull the underwater viewer 1 upwards such that the concave exterior of the lens 2 is pulled above the surface 9 of the body of water 8 but the interior lens cavity 12 remains filled with water because the one-way valve 6 does not allow fluid to flow back into the interior lens cavity 12, allowing a vacuum to remain in the interior lens cavity 12 and hold water in the interior lens cavity 12 above the surface 9 of the body of water 8. In a preferred variation, this allows large underwater viewer is to be created and used effectively. In another variation it allows the underwater viewer 1 to be used more easily. In another variation, an underwater viewer 1 with a one way valve mounted in communication with the interior lens cavity 12 is mounted to at least one of a surf board 10, a body board, and the hull of a water craft 11, and the one way valve allows the cavity 12 to fill with water as weight at least one of in and on the at least one of a surf board 10, a body board, and the water craft 11 pushes it down into the body of water 8. In a preferred variation, the one-way valve 6 can be closed by the user so that fluid cannot flow through it in either direction, which in a variation can prevent water from flowing into a water craft 11, and in another variation can prevent water from flowing onto the top of the at least one of the surf board 10 and the body board. In a preferred variation the one-way valve 6 is mounted to the lens 2 near the lens 2 apex 7, at a point on the lens 2 farthest from the plane of the frame 3, and in this preferred variation this makes it easiest to force all air out of the interior lens cavity 12. In another variation, the one-way valve 6 may be replaced with any type of valve and the user may close the valve when the interior lens cavity 12 is appropriately filled with water. The underwater viewer 1 may, however, have any suitable valve mounted to it to make the interior lens cavity 12 easier to fill with water. The underwater viewer 1 may, however, not have any type of valve mounted to it.

The shape of the lens 2 can be any faceted shape providing an interior with a volume capable of holding fluid and where a user can easily see through the facets 4 into the body of the water. The orientation of the facets 4 is preferably designed to provide easy viewing based on the intended use and user position associated with a particular variation of the underwater viewer 1.

In another preferred variation, a pump may be attached in fluid communication with the interior lens cavity 12 such that fluid may be pumped out of the interior lens cavity 12.

In another preferred variation, as shown in FIG. 7, at least one of the lens facets 4 includes at least one of a convex section 14 and a concave section 14, and at least one additional facet 4 of the lens is flat. In this preferred variation, this allows a user to look through at least one flat facet 4 and see an undistorted, magnification free view of the underwater environment, and the user is also able to look through at least one of a convex section 14 and a concave section 14 and see at least one of a wide angle view, and a magnified view. In another preferred variation, there is at least one convex section 14 and at least one concave section 14, as well as at least one flat facet 4 included in the facets of the lens.

In another preferred variation, the frame 3 is constructed such that a single flat facet of the lens is suspended at an angle underwater without requiring multiple lens facets. This is due to the design of the frame and the way it floats or sits in the water and having the single flat facet angled in the frame such that it sits at an angle relative to the level of the water. In this variation, the frame is designed to sustain a vacuum along with the single flat facet, still holding water in the cavity formed between the flat facet and the frame.

As a person skilled in the art will recognize from the previous detailed description and from the figures and claims, modifications and changes can be made to the preferred embodiments of the invention without departing from the scope of this invention defined in the following claims.

I claim:

1) An underwater viewer comprising: A transparent lens, wherein the transparent lens has at least two flat facets, wherein the at least two flat facets are arranged to provide an interior cavity having a void adapted to hold fluid; a frame, wherein the frame is attached around the circumference of the lens, wherein the joint between the lens and the frame is sealed to prevent fluid flow; wherein a user can look through the flat facets of the lens into a body of water.

2) The underwater viewer of claim 1, wherein a user grips the frame and places the underwater viewer in a body of water such that water fills the interior cavity of the lens and the concave outer surface of the lens is then oriented upward above the surface of the water, wherein a vacuum holds the water in the interior cavity of the lens above the surface of the water, wherein the water in the interior cavity of the lens provides a clear view into the body of water for the user, wherein the flat facets are adapted to not distort the image of light passing through the lens.

3) The underwater viewer of claim 1, wherein a one-way valve is attached to at least one of the frame and the interior cavity of the lens, wherein the one way-valve is adapted to allow fluid to flow out of the interior cavity of the lens but not into the interior cavity of the lens.

4) The underwater viewer of claim 2, wherein a one-way valve is attached to at least one of the frame and the interior cavity of the lens, wherein the one way-valve is adapted to allow fluid to flow out of the interior cavity of the lens but not into the interior cavity of the lens.

5) The underwater viewer of claim 3, wherein the one way valve is attached to the lens near the apex of the lens at the area farthest from the plane of the frame.

6) The underwater viewer of claim 4, wherein the one way valve is attached to the lens near the apex of the lens at the area farthest from the plane of the frame.

7) The underwater viewer of claim 3, wherein at least one of foam and an inflatable floatation bladder is attached to at least one of the frame and the lens.

8) The underwater viewer of claim 4, wherein at least one of foam and an inflatable floatation bladder is attached to at least one of the frame and the lens.

9) The underwater viewer of claim 5, wherein at least one of foam and an inflatable floatation bladder is attached to at least one of the frame and the lens.

10) The underwater viewer of claim 6, wherein at least one of foam and an inflatable floatation bladder is attached to at least one of the frame and the lens.

11) The underwater viewer of claim 1, wherein the viewer is mounted to at least one of a surf board, a body board, and the hull of a water craft.

12) The underwater viewer of claim 2, wherein the viewer is mounted to at least one of a surf board, a body board, and the hull of a water craft.

13) The underwater viewer of claim 3, wherein the viewer is mounted to at least one of a surf board, a body board, and the hull of a water craft, wherein the one-way valve is adapted to be closed by the user to prevent fluid flow in either direction.

14) The underwater viewer of claim 4, wherein the viewer is mounted to at least one of a surf board, a body board, and the hull of a water craft, wherein the one-way valve is adapted to be closed by the user to prevent fluid flow in either direction.

15) The underwater viewer of claim 5, wherein the viewer is mounted to at least one of a surf board, a body board, and the hull of a water craft, wherein the one-way valve is adapted to be closed by the user to prevent fluid flow in either direction.

16) The underwater viewer of claim 6, wherein the viewer is mounted to at least one of a surf board, a body board, and the hull of a water craft, wherein the one-way valve is adapted to be closed by the user to prevent fluid flow in either direction.

17) The underwater viewer of claim 1, wherein at least one lens facet is at least one of concave and convex, wherein at least one additional lens facet is flat, wherein including at least one flat facet and at least one of a concave section and a convex section allows the user to view the underwater environment through both of a magnification and distortion free view and also at least one of a magnified and a wide angle view.

18) The underwater viewer of claim 17, wherein both a convex and a concave facet are included.

19) The underwater viewer of claim 4, wherein at least one lens facet is at least one of concave and convex, wherein at least one additional lens facet is flat, wherein including at least one flat facet and at least one of a concave section and a convex section allows the user to view the underwater environment through both of a magnification and distortion free view and also at least one of a magnified and a wide angle view.
